(19) United States
(12) Patent Application Publication
(10) Pub. No.: US 2020/0395791 A1
(43) Pub. Date: Dec. 17, 2020

(54) LASER WIRELESS PATH SEGMENTATION CHARGING SYSTEM

(71) Applicant: THUNDER POWER NEW ENERGY VEHICLE DEVELOPMENT COMPANY LIMITED, Central (HK)

(72) Inventor: Li Chung Yung, Tapei (TW)

(73) Assignee: THUNDER POWER NEW ENERGY VEHICLE DEVELOPMENT COMPANY LIMITED, Central (HK)

(21) Appl. No.: 16/440,991

(22) Filed: Jun. 14, 2019

(51) Int. Cl. H02J 50/30; H02J 7/02; B60L 53/51; B60L 53/10; B60L 53/60; B60L 53/30

(52) U.S. Cl. CPC H02J 50/30; H02J 7/025; B60L 53/30; B60L 53/10; B60L 53/60; B60L 53/51

(57) ABSTRACT

Provided is an EV charging station comprising a housing, a laser, a set of lens, and a control unit. The housing receives electric power from a power grid. The laser converts the received electrical power into laser beams, and transfer the laser beams to a transportation apparatus through the set of lens. The laser comprises multiple electro-laser conversion units. The electro-laser conversion unit converts the received electric power to laser beam. The set of lens transfers laser beams on a photovoltaic module provided in the transportation apparatus. The control unit controls laser beams converted by the electro-laser conversion units to be transferred to the lens in the set.

### BACKGROUND OF THE INVENTION

This invention relates generally to EV charging system, and more particularly, to a laser wireless path segmentation charging system.

To refuel a conventional liquid or gas powered vehicle takes a matter of minutes, an electric vehicle however may take hours depending upon the battery type and charger specifications. In addition to the long time taken to re-fuel, there is an even simpler problem that is inherent to electric vehicles, to recharge they need an electrical supply. In built up urban areas, such as cities and the like, vehicle owners may not have a defined private parking space with a power supply in site. This is especially apparent with high density apartment style dwellings found in most major cities.

An electric vehicle charging station, also called EV charging station, electric recharging point, charging point, or charge point and EVSE (electric vehicle supply equipment), is an element in an infrastructure that supplies electric energy for the recharging of electric vehicles, such as plug-in electric vehicles, including electric cars, neighborhood electric vehicles and plug-in hybrids. As electric vehicles and battery electric vehicle ownership is expanding, there is a growing need for widely distributed publicly accessible charging stations, some of which support faster charging at higher voltages and currents than are available from residential EVSEs. Many charging stations are on-street facilities provided by electric utility companies or located at retail shopping centers and operated by many private companies. These charging stations provide one or a range of special connectors that conform to the variety of electric charging connector standards. Electric vehicles currently must be plugged in to a specially designed outlet to receive power for charging the batteries, which limits the widely use of EVs. As an alternative, wireless charging doesn't need specially designed outlet in charging station side or connectors in EV side, which improves use of EVs.

Wireless power transfer (WPT), wireless power transmission, wireless energy transmission (WET), or electromagnetic power transfer is the transmission of electrical energy without wires as a physical link. Wireless power techniques mainly fall into two categories, near field and far-field. In near field or non-radiative techniques, power is transferred over short distances by magnetic fields using inductive coupling between coils of wire, or by electric fields using capacitive coupling between metal electrodes. Inductive coupling is the most widely used wireless technology; its applications include charging handheld devices like phones and electric toothbrushes, RFID tags, and wirelessly charging or continuous wireless power transfer in implantable medical devices like artificial cardiac pacemakers, or electric vehicles. In far-field or radiative techniques, also called power beaming, power is transferred by beams of electromagnetic radiation, like microwaves. These techniques can transport energy longer distances but must be aimed at the receiver. Proposed applications for this type are solar power satellites, and wireless powered drone aircraft.

In a conventional wireless power transmission system, a transmitter device, driven by electric power from a power source, generates a time-varying electromagnetic field, which transmits power across space to a receiver device, which extracts power from the field and supplies it to an electrical load. The technology of the wireless power transmission can eliminate the use of the wires and batteries, thus increasing the mobility, convenience, and safety of an electronic device for all users. Wireless power transfer is useful to power electrical devices where interconnecting wires are inconvenient, hazardous, or are not possible.

### BRIEF SUMMARY OF THE INVENTION

Provided is an EV charging station comprising a housing, a laser, a set of lens, and a control unit. The housing receives electric power from a power grid. The laser converts the received electrical power into laser beams, and transfer the laser beams to a transportation apparatus through the set of lens. The laser comprises multiple electro-laser conversion units. The electro-laser conversion unit converts the received electric power to laser beam. The set of lens transfers laser beams on a photovoltaic module provided in the transportation apparatus. The control unit controls laser beams converted by the electro-laser conversion units to be transferred to the lens in the set.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

FIG. 1 generally illustrates a system for laser wireless path segmentation charging in accordance with the disclosure.

FIG. 2 illustrates an embodiment of a system comprising laser and beam splitter.

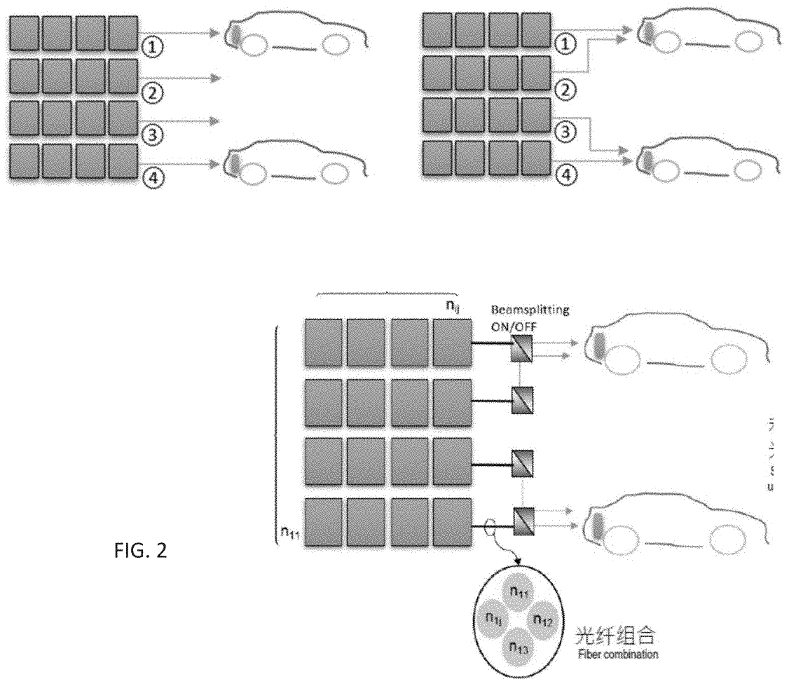

FIG. 3 illustrates one exemplary EV charging method in accordance with the disclosure.

FIG. 4 illustrates a simplified computer system, according to an exemplary embodiment of the present disclosure.

### DETAILED DESCRIPTION OF THE INVENTION

In accordance with the disclosure, embodiments can provide a method and system for automatic generation of lane centerline. Various specific embodiments of the present disclosure will be described below with reference to the accompanying drawings constituting a part of this specification. It should be understood that, although structural parts and components of various examples of the present disclosure are described by using terms expressing directions, e.g., “front”, “back”, “upper”, “lower”, “left”, “right” and the like in the present disclosure, these terms are merely used for the purpose of convenient description and are determined on the basis of exemplary directions displayed in the accompanying drawings. Since the embodiments disclosed by the present disclosure may be set according to different directions, these terms expressing directions are merely used for describing rather than limiting. Under possible conditions, identical or similar reference numbers used in the present disclosure indicate identical components.

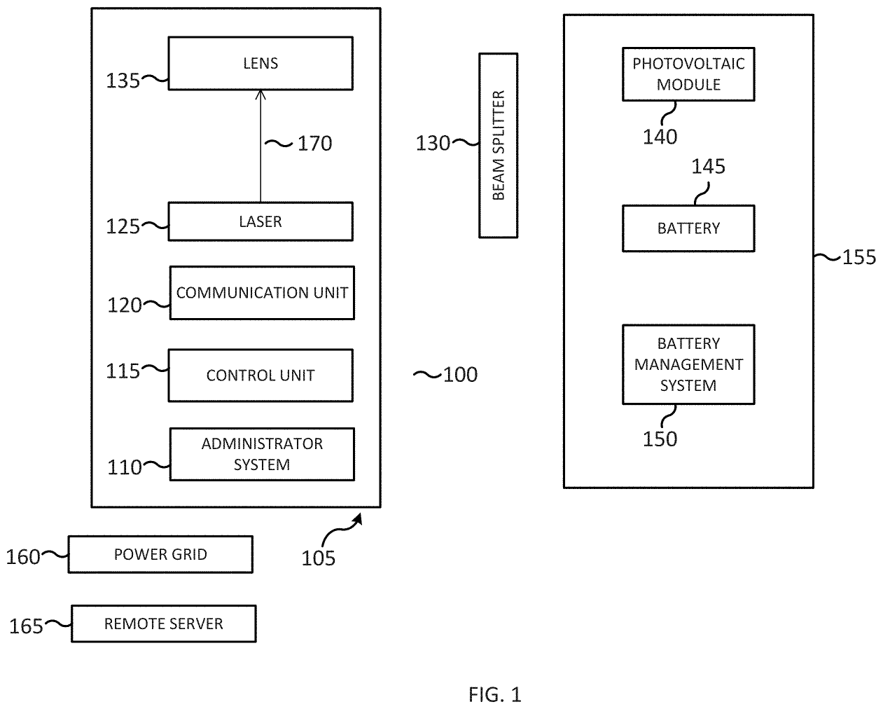

Various exemplary embodiments are directed to a charging station 100 to charge electric vehicle 155 wirelessly through laser. As shown in the example of FIG. 1, charging station 100 may include: housing 105, control unit 115, communication unit 120, laser 125, beam splitter 130, fiber line 170, and lens 135. Vehicle 155 may include: photovoltaic module 140 and battery 145.

Charging station 100 may be utilized for personal and commercial electric vehicle 155. Charging station 100 may be placed in designated areas on public streets and on private or city land, such as garages and warehouses used to park or store personal and commercial electric vehicle 155. Though charging station 100 may be placed anywhere, placement may be optimized to support and promote electric charging in specific zones. Charging station 100 may also be effective, for example for commercial vehicle 155, in designated loading zones.

The housing 105 may contain various electronic and mechanical components associated with the charging station 100. For example, a lens 135 is positioned in the housing 105. The lens 135 may be positioned proximate the vehicle 155 in order to reduce the distance between the lens 135 and a photovoltaic module 140 positioned on the vehicle 155. The lens 135 is capable of wirelessly transmitting laser power to the photovoltaic module 140 and may be capable of fast charging at higher voltages and currents. The lens 135 and the photovoltaic module 140 may include various configurations having different sizes, orientations, and made from different materials for transmitting and receiving power through laser. The photovoltaic module 140 is electrically connected to a battery 145 which may include one or more rechargeable batteries and a battery management system 150. In an exemplary embodiment, the battery management system 150 is capable of monitoring one or more properties of the batteries, for example charge level, charging rate, temperature, and usage efficiency. The photovoltaic module 140 is capable of transferring power received from the charging station 100 to charge the batteries. Various electrical components such as power converters, rectifiers and various control units may be associated with the lens 135 and the photovoltaic module 140.

The laser 125 is a device that emits light through a process of optical amplification based on the stimulated emission of electromagnetic radiation. The laser is configured to convert the received electrical power into laser beams, and transfer the laser beams to a transportation apparatus through the set of lens, and the laser comprises multiple electro-laser conversion units. According to different embodiments, various types of lasers can be employed here, such as solid-state laser, gas laser, liquid laser, semiconductor laser, and etc.

The lens 135 is a transmissive optical device that focuses laser beam by means of refraction. According to different embodiments, various types of lens can be employed here, such as biconvex lens, and etc.

The beam splitter 130 is an optical device that splits a beam of light in two or more beams. In its most common form, a cube, it is made from two triangular glass prisms which are glued together at their base using polyester, epoxy, or urethane-based adhesives. The thickness of the resin layer is adjusted such that (for a certain wavelength) half of the light incident through one “port” (i.e., face of the cube) is reflected and the other half is transmitted due to frustrated total internal reflection. Polarizing beam splitters, such as the Wollaston prism, use birefringent materials, splitting light into beams of differing polarization. Another design is the use of a half-silvered mirror, a sheet of glass or plastic with a transparently thin coating of metal, now usually aluminium deposited from aluminium vapor. The thickness of the deposit is controlled so that part (typically half) of the light which is incident at a 45-degree angle and not absorbed by the coating is transmitted, and the remainder is reflected. A very thin half-silvered mirror used in photography is often called a pellicle mirror. To reduce loss of light due to absorption by the reflective coating, so-called “swiss cheese” beam splitter mirrors have been used. Originally, these were sheets of highly polished metal perforated with holes to obtain the desired ratio of reflection to transmission. Later, metal was sputtered onto glass so as to form a discontinuous coating, or small areas of a continuous coating were removed by chemical or mechanical action to produce a very literally “half-silvered” surface. Instead of a metallic coating, a dichroic optical coating may be used. Depending on its characteristics, the ratio of reflection to transmission will vary as a function of the wavelength of the incident light.

The administrator system 110 may be capable of performing various tasks and operations such as monitoring, management, customer service and support, and/or scheduling. The administrator system 110 may be capable of controlling, monitoring, testing or calibrating the components in the charging station 100. The administrator system 110 may also be capable of sending alerts to users, authorities, and other relevant parties, for example police, fire, medical services, or towing services.

The control unit 115 is configured to control electro-laser conversion units in the laser, the beam splitters, and the set of lens under instruction of the administrator system 110. The control unit 115 may control laser beams converted by the electro-laser conversion units to be transferred to one or more lens. For example, the control unit 115 may control the first laser beam converted by the first electro-laser conversion unit and the second laser beam converted by the second electro-laser conversion unit to be transferred to the first lens. For another example, the control unit 115 may control the first laser beam converted by the first electro-laser conversion unit to be transferred to the first and second lens through the beam splitter 130.

The control unit 115 may include various electronic, mechanical, and/or electromechanical components to perform various control, analytical, and communication functions such as those described herein. The control unit 115 may include one or more microcontrollers, such as an Arduino board to perform dedicated tasks and functions. Though the control unit 115 is depicted and described as a single unit for clarity, it may be comprised of several individual units, working together or in isolation, to perform the various functions described herein.

The control unit 115 may be connected to a power source, for example an electrical utility line. The control unit 115 may contain various electronic components to convert or modify the power received from the power source and supply the laser 125 with power in an appropriate amount, having the correct current and frequency. The control unit 115 is capable of selectively powering the laser 125 at appropriate times, such as by activating the laser 125 when a vehicle 155 is detected or a request for charging is received, or by deactivating the laser 125 when a vehicle 155 leaves or the battery 145 is completely charged.

The control unit 115 may contain, or be connected to, a communication unit 120 to receive and transmit information from various sources. The communication unit 120 may receive and transmit information through a wired connection and/or wirelessly. Wired connections may be achieved through one or more data or network ports. Wireless communication may be achieved through radio frequency, Bluetooth, or WiFi wireless transmission as well as optic, infrared, or other light signaling. The communication unit 120 may be in communication, either through a data connection or an electrical connection to receive and transmit information for other components in the charging station 100. The communication unit may also communicate with devices and locations outside of the charging station 100. The controller 115 and the communication unit 120 may incorporate a beagleboard or beaglebone type device to provide computing and communication functionality.

In various exemplary embodiments, the communication unit 120 transmits and receives information to and from various external devices such as the battery management system 150, the sensors, and one or more mobile devices. Mobile devices may include any mobile electronic device, such as a mobile phone, tablet, laptop or other computing device. The mobile device may also be a vehicle related device, such as a global positioning device (GPS), dashboard or other onboard, vehicle computer. A vehicle related mobile device may be a dedicated unit or integrated with the vehicle 155 to perform different functions. The mobile device may be capable of receiving information related to the vehicle 155, for example position, battery level, and charging rate. Accordingly, the battery management system 150 may also be able to communicate directly with one or more mobile devices.

The communication unit 120 may also be capable of transmitting and receiving information to and from a remote server 165. The remote server 165 may include a dedicated server or a storage network, such as a cloud computing network. The communication unit 120 transmits information to the remote server 165 via the Internet or a dedicated network, either through a hardwired connection or wireless connection as discussed above. In various exemplary embodiments, the sensors communicate with the remote server 165 directly or through the communication unit 120. Information sent to the remote server 165 may include operating status, occupancy status, charging efficiency and statics, sensor data, and usage data. The remote server 165 may also communicate with the mobile device and other devices, such as an additional user device as well as an administrator system 110. The user device may include any user computing device such as a mobile device described above or a stationary computer or terminal.

In various exemplary embodiments, the remoter server 165 may be designed to interact with one or more databases for storing information relating to different charging station 100, different vehicle 155, and/or different users. The server 165 may implement a database management system for storing, compiling, and organizing data, and to allow a user and administrators to access and search the stored data. The databases may contain different units for storing data related to different topics, for example charging station 100 information, user account information, and vehicle 155 information.

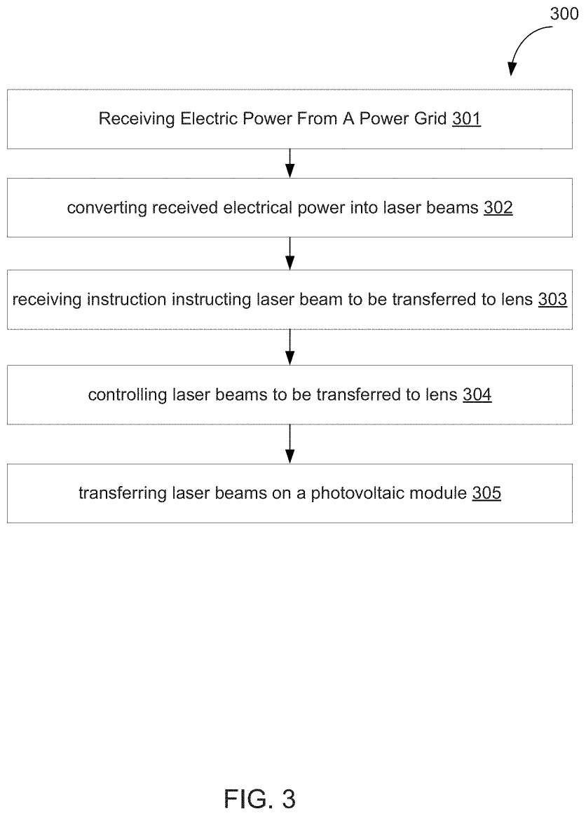

FIG. 3 illustrates one exemplary EV charging method in accordance with the disclosure. The operations of method 300 presented below are intended to be illustrative. In some embodiments, method 300 may be accomplished with one or more additional operations not described and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At 301, the method 300 includes receiving electric power from a power grid. In some implementations, operation 301 can be performed by a housing substantially similar to or the same as the housing 105 as described and illustrated herein.

At 302, the method 300 includes converting, by a laser in the housing, the received electrical power into laser beams, wherein the laser comprises multiple electro-laser conversion units including a first electro-laser conversion unit, wherein the first electro-laser conversion unit is configured to convert at least part of the received electric power to a first laser beam. In some implementations, operation 302 can be performed by a laser substantially similar to or the same as the laser 125 as described and illustrated herein.

At 303, the method 300 includes receiving, by a control unit in the housing, an instruction from an administrator system instructing the laser beams to be transferred to a set of lens in the housing. In some implementations, operation 303 can be performed by a control unit substantially similar to or the same as the control unit 115 as described and illustrated herein.

At 304, the method 300 includes controlling, by the control unit, the laser beams converted by the multiple electro-laser conversion units to be transferred to the set of lens. In some implementations, operation 304 can be performed by a control unit substantially similar to or the same as the control unit 115 as described and illustrated herein.

At 305, the method 300 includes transferring, by the set of lens, the laser beams on a photovoltaic module provided in a transportation apparatus, wherein the set of lens includes a first lens connected with the first electro-laser conversion unit through a first fiber line. In some implementations, operation 305 can be performed by a lens substantially similar to or the same as the lens 135 as described and illustrated herein.

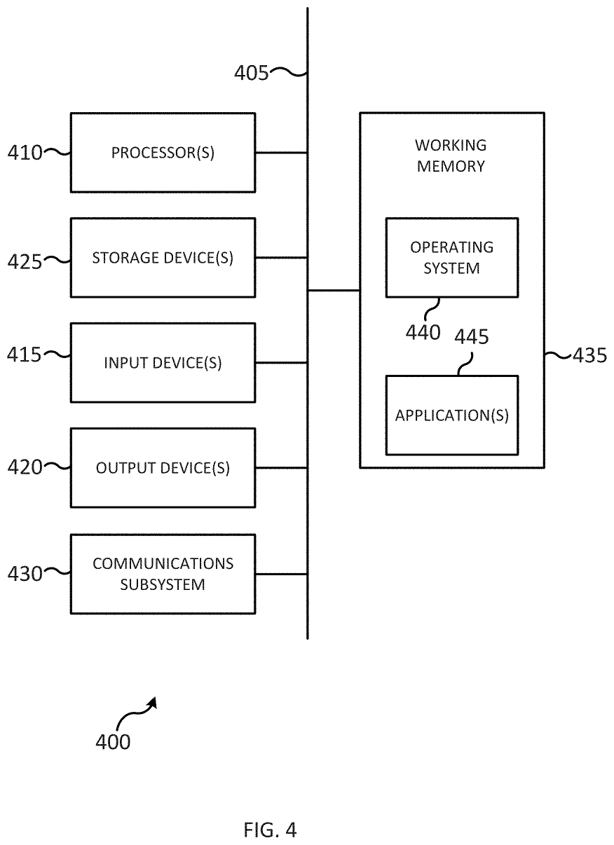

FIG. 4 illustrates a simplified computer system that can be used implement various embodiments described and illustrated herein. A computer system 400 as illustrated in FIG. 4 may be incorporated into devices such as a portable electronic device, mobile phone, or other device as described herein. FIG. 4 provides a schematic illustration of one embodiment of a computer system 400 that can perform some or all of the system provided by various embodiments. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405, or may otherwise be in communication, as appropriate. The hardware elements may include one or more processors 410, including without limitation one or more general-purpose processors and/or one or more special-purpose processors such as digital signal processing chips, graphics acceleration processors, and/or the like; one or more input devices 415, which can include without limitation a mouse, a keyboard, a camera, and/or the like; and one or more output devices 420, which can include without limitation a display device, a printer, and/or the like.

The computer system 400 may further include and/or be in communication with one or more non-transitory storage devices 4150, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 400 might also include a communications subsystem 430, which can include without limitation a modem, a network card (wireless or wired), an infrared communication device, a wireless communication device, and/or a chipset such as a Bluetooth™ device, an 1002.11 device, a WiFi device, a WiMax device, cellular communication facilities, etc., and/or the like. The communications subsystem 430 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 430. In other embodiments, a portable electronic device, e.g. the first electronic device, may be incorporated into the computer system 400, e.g., an electronic device as an input device 415. In some embodiments, the computer system 400 will further comprise a working memory 435, which can include a RAM or ROM device, as described above.

The computer system 400 also can include software elements, shown as being currently located within the working memory 435, including an operating system 440, device drivers, executable libraries, and/or other code, such as one or more application programs 445, which may comprise computer programs provided by various embodiments, and/or configure systems, provided by other embodiments, as described herein. Merely by way of example, one or more procedures described with respect to the system discussed above, such as those described in relation to FIG. 4, might be implemented as code and/or instructions executable by a computer and/or a processor within a computer; in an aspect, then, such code and/or instructions can be used to configure and/or adapt a general purpose computer or other device to perform one or more operations in accordance with the described system.

A set of these instructions and/or code may be stored on a non-transitory computer-readable storage medium, such as the storage device(s) 4150 described above. In some cases, the storage medium might be incorporated within a computer system, such as computer system 400. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 400 and/or might take the form of source and/or installable code, which, upon compilation and/or installation on the computer system 400 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 400 to perform system in accordance with various embodiments of the technology. According to a set of embodiments, some or all of the procedures of such methods are performed by the computer system 400 in response to processor 410 executing one or more sequences of one or more instructions, which might be incorporated into the operating system 440 and/or other code, such as an application program 445, contained in the working memory 435. Such instructions may be read into the working memory 435 from another computer-readable medium, such as one or more of the storage device(s) 4150. Merely by way of example, execution of the sequences of instructions contained in the working memory 435 might cause the processor(s) 410 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 400, various computer-readable media might be involved in providing instructions/code to processor(s) 410 for execution and/or might be used to store and/or carry such instructions/code. In many embodiments, a computer-readable medium is a physical and/or tangible storage medium. Such a medium may take the form of a non-volatile media or volatile media. Non-volatile media include, for example, optical and/or magnetic disks, such as the storage device(s) 4150. Volatile media include, without limitation, dynamic memory, such as the working memory 435.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400.

The communications subsystem 430 and/or components thereof generally will receive signals, and the bus 405 then might carry the signals and/or the data, instructions, etc. carried by the signals to the working memory 435, from which the processor(s) 410 retrieves and executes the instructions. The instructions received by the working memory 435 may optionally be stored on a non-transitory storage device 4150 either before or after execution by the processor(s) 410.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including embodiments. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a sensor” includes a plurality of sensors, and reference to “the processor” includes reference to one or more processors and equivalents thereof known to those skilled in the art, and so forth. Ordinals such as “first sensor” and “second sensor” only mean they may be different. There is no specific sequence unless the context clearly dictates otherwise. Thus, for example, “first sensor” can be described as “second sensor”, and vice versa.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

What is claimed is:

1. An EV charging station comprises:
a housing, a laser, a set of lens, a control unit; and, wherein
the housing is configured to receive electric power from a power grid;
the laser is configured to convert the received electrical power into laser beams, and transfer the laser beams to a transportation apparatus through the set of lens, wherein the laser comprises multiple electro-laser conversion units including a first electro-laser conversion unit, wherein the first electro-laser conversion unit is configured to convert at least part of the received electric power to a first laser beam;
the set of lens are configured to transfer one or more laser beams on a photovoltaic module provided in the transportation apparatus, wherein the set of lens includes a first lens connected with the first electro-laser conversion unit through a first fiber line; and
the control unit is configured to control one or more laser beams converted by one or more of the electro-laser conversion units to be transferred to one or more of the lens in the set, wherein the control unit is configured to control the first laser beam to be transferred to the first lens.

2. The EV charging station according to claim 1, wherein the electro-laser conversion units are arranged within the housing as a rectangular matrix.

3. The EV charging station according to claim 1, wherein the control unit is configured to receive a first instruction from an administrator system instructing the first laser beam to be transferred to the first lens, and to receive a second instruction from the administrator system instructing a second laser beam to be transferred to a second lens in the set.

4. The EV charging station according to claim 1, wherein the electro-laser conversion units includes a second electro-laser conversion unit connected with the first lens through a second fiber line, the second electro-laser conversion unit being configured to convert the received electrical power to a second laser beam, and wherein the control unit is configured to control the second laser beam to be transferred to the first lens.

5. The EV charging station according to claim 4, wherein the control unit is configured to receive a first instruction from an administrator system instructing the second laser beam to be transferred to the second lens, and to receive a second instruction from the administrator system instructing the second laser beam to be transferred to a second lens in the set.

6. The EV charging station according to claim 4, wherein the control unit is configured to receive a third instruction from an administrator system instructing the first laser beam and second laser beam to be transferred to the first lens.

7. The EV charging station according to claim 4, wherein the control unit is configured to receive a fourth instruction from an administrator system instructing the first laser beam to be transferred to the first lens and second laser beam to be transferred to the second lens.

8. The EV charging station according to claim 4, wherein the second electro-laser unit is connected with a second lens in the set through a second fiber line.

9. The EV charging station according to claim 1, wherein the control unit is configured to change pointing direction of the set of lens.

10. The EV charging station according to claim 1, further comprises a set of beam splitters configured to split the laser beams transferred by the set of lens; and the control unit is configured to change pointing direction of the set of beam splitters.

11. An EV charging method comprises:
receiving, by a housing in an EV charging station, electric power from a power grid;
converting, by a laser in the housing, the received electrical power into laser beams, wherein the laser comprises multiple electro-laser conversion units including a first electro-laser conversion unit, wherein the first electro-laser conversion unit is configured to convert at least part of the received electric power to a first laser beam;
receiving, by a control unit in the housing, an instruction from an administrator system instructing the laser beams to be transferred to a set of lens in the housing;
controlling, by the control unit, the laser beams converted by the multiple electro-laser conversion units to be transferred to the set of lens; and
transferring, by the set of lens, the laser beams on a photovoltaic module provided in a transportation apparatus, wherein the set of lens includes a first lens connected with the first electro-laser conversion unit through a first fiber line.

12. The EV charging method according to claim 11, wherein the electro-laser conversion units are arranged within the housing as a rectangular matrix.

13. The EV charging method according to claim 11, further comprises:
receiving, by the control unit, a first instruction from the administrator system instructing the first laser beam to be transferred to the first lens;
receiving, by the control unit, a second instruction from the administrator system instructing a second laser beam to be transferred to a second lens.

14. The EV charging method according to claim 11, wherein the electro-laser conversion units includes a second electro-laser conversion unit connected with the first lens through a second fiber line, the second electro-laser conversion unit being configured to convert the received electrical power to a second laser beam, and wherein the control unit is configured to control the second laser beam to be transferred to the first lens.

15. The EV charging method according to claim 11, wherein the control unit is configured to receive a first instruction from an administrator system instructing the second laser beam to be transferred to the second lens, and to receive a second instruction from the administrator system instructing the second laser beam to be transferred to a second lens in the set.

16. The EV charging method according to claim 11, wherein the control unit is configured to receive a third instruction from an administrator system instructing the first laser beam and second laser beam to be transferred to the first lens.

17. The EV charging method according to claim 11, wherein the control unit is configured to receive a fourth instruction from an administrator system instructing the first laser beam to be transferred to the first lens and second laser beam to be transferred to the second lens.

18. The EV charging method according to claim 11, wherein the second electro-laser unit is connected with a second lens in the set through a second fiber line.

19. The EV charging method according to claim 11, wherein the control unit is configured to change pointing direction of the set of lens.

20. The EV charging method according to claim 11, further comprises a set of beam splitters configured to split the laser beams transferred by the set of lens; and the control unit is configured to change pointing direction of the set of beam splitters.
